(19) United States
(12) Patent Application Publication
(10) Pub. No.: US 2026/0099037 A1
(43) Pub. Date: Apr. 9, 2026

(54) Microscope and Method for Microscopy

(71) Applicant: Carl Zeiss Microscopy GmbH, Jena (DE)

(72) Inventors: Thomas Ohrt, Golmsdorf (DE); Philipp Holz, Jena (DE); Nils Langholz, Apolda (DE); Julia Eva Koenig, Grebenhain (DE)

(21) Appl. No.: 19/350,362

(22) Filed: Oct. 6, 2025

(30) Foreign Application Priority Data
Oct. 8, 2024 (DE) 10 2024 128 995.3

(51) Int. Cl. G02B 21/30; G02B 21/26; G02B 21/28

(52) U.S. Cl. CPC G02B 21/30; G02B 21/26; G02B 21/28

(57) ABSTRACT

A microscope having a microscope stand, having at least one microscope objective arranged on the microscope stand, having a holding frame for receiving a sample or a sample carrier and having a sample stage comprising a receiving device for receiving the holding frame. The microscope includes an incubator module that is arrangeable on the holding frame and furthermore wherein the incubator module and the holding frame jointly enclose a sample space at least in part and the holding frame is free from active devices for climate control in the sample space. A system having a plurality of different holding frames and a plurality of different incubator modules for a microscope is described.

The current application claims the benefit of German Patent Application No. 10 2024 128 995.3, filed on 8 Oct. 2024, which is hereby incorporated by reference.

In a first aspect, the invention relates to a microscope according to the preamble of claim 1. In a further aspect, the invention relates to a system having a plurality of different holding frames and a plurality of different incubator modules for a microscope, according to the preamble of claim 29. Numerous configurations of such microscopes and systems are known.

A generic microscope comprises at least the following constituent parts: a microscope stand, at least one microscope objective arranged on the microscope stand, a holding frame for receiving at least one sample and/or at least one sample carrier and/or at least one combination of a sample and a sample carrier, and a sample stage comprising a receiving device for receiving the holding frame.

Modern modular, flexible microscopes usually have motorized or manual xy-sample stages that allow a sample to be displaced laterally in order to bring desired areas of the sample into the field of view. Very different samples are examined using these microscopes. To avoid the need to use different sample stages for different samples, use is made of different holding frames that in each case provide a suitable support or receptacle for the respective sample and sample carrier. These different holding frames may be designed in such a way that they can be arranged or assembled on the same sample stage. Thus there is a mechanical interface between the holding frame and the sample stage.

Modules for controlling the temperature of a space in the vicinity of the sample and/or for introducing gas into said space are available in order to provide suitable temperature and atmospheric conditions for biological samples.

Variants of such incubation modules comprise special heatable holding frames with a lid. Suitable, generally different, heatable holding frames are available in each case for different samples or sample holders.

It may be considered to be a substantial disadvantage of the known solutions that a comparatively large number of different holding frames must be kept available in order to provide solutions for as many different sample types and as many different examination methods as possible. This results in high procurement costs for the customer and much complexity on part of the vendor as regards development costs, product care and distribution.

One problem addressed by the present invention can be considered that of providing a microscope and a system having different holding frames and different incubator modules for a microscope, in the case of which the aforementioned disadvantages can be avoided at least in part.

This problem is solved by the microscope having the features of claim 1 and by the system having the features of claim 29.

Advantageous exemplary embodiments of the microscope according to the invention and of the system according to the invention will be explained below, in particular in connection with the dependent claims and the figures.

According to the invention, the microscope of the type specified above is developed by way of an incubator module that is arrangeable on the holding frame and is furthermore characterized in that the incubator module and the holding frame jointly enclose a sample space at least in part and in that the holding frame is free from active devices for climate control in the sample space.

According to the invention, the system of the type specified above is characterized in that each of the holding frame comprises a holding-frame-side interface, in that each of the incubator modules comprises an incubator-side interface and in that each of the holding-frame-side interfaces can be made to engage with each of the incubator-side interfaces when used as intended.

In principle, the microscope may be any desired optical microscope that in principle is configured for any desired microscopy method. In particular, the microscope might be a wide-field microscope or a scanning microscope, a light sheet microscope, a light field microscope and/or a fluorescence microscope.

The term microscope stand denotes those components of the microscope that are generally arranged in stationary fashion, for example on a workbench. As essential constituent part, the microscope stand typically comprises a metallic frame or a metallic housing, for example an aluminum die-cast housing.

The microscope objective can be any desired microscope objective, in particular any commercially available microscope objective, which is expediently selected in suitable fashion for the respective desired microscopy method.

The term sample stage denotes a mechanical component that is configured to keep a sample to be examined at a defined spatial position and with a defined spatial orientation relative to the microscope objective.

The term holding frame denotes a mechanical component, for example a frame-shaped mechanical component, which is configured to be arranged on the sample stage. For this purpose, the sample stage comprises a suitably designed receiving device, for example with a depression and/or suitable mechanical stops. The receiving device serves to hold the holding frame in a defined spatial position on the sample stage. Furthermore, the holding frame serves to position a sample holder or a sample with a defined spatial arrangement relative to the microscope objective.

The basic idea of the present invention can be considered that of no active devices serving for the climate control in a sample space being present on the holding frame, in contrast to solutions from the prior art. In this sense, the holding frame is, according to the invention, free from active devices for climate control in the sample space. These configurations of the holding frame are also referred to as purely passive configurations, and the holding frames are correspondingly referred to as purely passive holding frames. The holding frame of the microscope according to the invention consequently satisfies substantially a mechanical function. Optionally, thermal conduction properties of the holding frame can be suitably designed and rendered usable.

The advantage achieved thereby is that the holding frame or the holding frames can be implemented comparatively easily and consequently cost-effectively.

According to the invention, the incubator module, which according to the invention should be arranged on the holding frame, together with the holding frame jointly at least partly encloses a sample space in which a sample to be examined is arranged during intended use.

The feature according to the invention whereby the incubator module is arrangeable on the holding frame is intended to mean that the incubator module can be arranged on the holding frame.

The term holding-frame-side interface refers to those features of the configuration of the holding frame relating in particular to shaping, material and/or surface in those regions of the holding frame in which the holding frame comes into mechanical contact with the incubator module when the incubator module is arranged on the holding frame as intended.

The term incubator-side interface refers to those features of the configuration of the incubator module relating in particular to shaping, material and/or surface in those regions of the incubator module in which the incubator module comes into mechanical contact with the holding frame when the incubator module is arranged on the holding frame as intended.

In a situation in which an incubator module is arranged on a holding frame as intended, the relevant incubator module is brought into engagement as intended with the relevant holding frame.

Firstly, the present invention has recognized that there is no need to provide active devices for climate control in a sample space on the holding frame or frames.

Furthermore, the present invention has recognized that it is possible to attach, in particular exclusively attach, the active devices required for climate control in a sample space, for example devices for separating the sample space and/or introducing gas into the sample space, to special incubator modules.

It may be considered to be a substantial advantage of the present invention that, in comparison with solutions from the prior art, the same number of different samples can be examined and the same number of different sample conditions can be realized using fewer and more cost-effective components, i.e. holding frames and incubator modules.

A further important advantage of the present invention is that the quality of temperature control attainable using the arrangement according to the invention is substantially the same as that rendered possible by systems with heated holding frames.

The microscope stand may be an upright stand, in which the microscope objective has a line of sight from above to a sample to be examined. However, the microscope stand may also be an inverted stand, in which the microscope objective is directed from below at a sample to be examined. Such an arrangement is frequently preferred for the examination of biological samples.

In the simplest configuration, the sample stage may be a stationary sample stage. However, the sample stage in preferred variants is an xy-displacement stage that is adjustable at least in the lateral directions, i.e. transversely to the direction of an optical axis of the microscope objective. Moreover, an option for an adjustment in the direction of the optical axis of the microscope objective is particularly preferably provided. Such sample stages may be referred to as xyz-displacement stages. In this context it is possible that the microscope objective is adjusted relative to the microscope stand in the direction of the optical axis and relative to the sample stage, but it is also possible that the microscope objective is not moved relative to the microscope stand and instead the sample stage is moved relative to the microscope objective in the direction of the optical axis.

The microscope objective can typically be arranged with a plurality of different microscope objectives in an objective changer, for example a linear changer or an objective turret.

In more complicated solutions, the sample stage may also be rotatable or swivelable about at least one axis. For example, the sample stage may be rotatable or swivelable about at least an axis that is parallel to an optical axis of the microscope objective.

Furthermore, the sample stage may be manually adjustable. In preferred configurations, the sample stage comprises a motorized drive or a plurality of motorized drives, which may be controlled by a control unit in particular.

Finally, an automated sample feed might be present for the purpose of equipping the microscope according to the invention with samples to be examined.

At least one securing device may be present for securing the holding frame to the sample stage. The securing device may comprise at least one mechanical clamping device and/or at least one magnetic device.

In a preferred variant of the microscope according to the invention, the sample stage comprises a device for varying the distance of the holding frame, in particular in the direction of an optical axis of the microscope objective, relative to the microscope objective. Such a device can bring about minor modifications to a distance of the sample to be examined relative to the microscope objective without needing to actuate a z-drive optionally present.

As a matter of principle, the device for varying the distance may be manually actuatable. In a particularly preferred configurations, the device for varying the distance comprises a piezo actuator.

By preference, the microscope may comprise a control unit, for example a PC, for controlling components of the microscope. The control unit may be expediently configured to control at least one of the following components: motorized drive or motorized drives of the sample stage, objective changer, device for varying the distance of the holding frame relative to the microscope objective.

A mechanical interface is expediently formed between the incubator module and the holding frame in order to provide a defined sample space, in particular a sample space with controllable climate. The mechanical interface may comprise an incubator-side interface on the incubator module. Furthermore, the mechanical interface may comprise a holding-frame-side interface on the holding frame. The mechanical interface is preferably configured to thermally isolate the sample space and a region outside the sample space from each other.

In a particularly preferred configuration, the interface is configured to allow thermal conduction between the incubator module and a part of the holding frame facing the sample space, said thermal conduction being greater than thermal conduction between the incubator module and a part of the holding frame facing away from the sample space.

In a configuration that can be realized with comparatively little outlay, the incubator-side interface and/or the holding-frame-side interface comprises a groove, and the respective other interface comprises a protruding collar configured to engage in the groove. The protruding collar may also be referred to as a key. The protruding collar or the key may for example be configured to interlockingly engage in the groove.

In a particularly preferred exemplary embodiment, the protruding collar or the key and the groove are designed in such a way that when the protruding collar engages in the groove, the protruding collar contacts a radially interior wall of the groove and forms an air gap with respect to a radially outer wall of the groove. This variant allows thermal conduction between the incubator module and a part of the holding frame facing the sample space to be greater than thermal conduction between the incubator module and a part of the holding frame facing away from the sample space.

In a simple variant, the incubator module may be configured to be placed on the holding frame. However, it is also possible that at least one of the components of holding frame and incubator module comprises at least one mechanical securing device for securing the incubator module to the holding frame. For example, at least one such mechanical securing device may comprise at least one mechanical clamp or be implemented by way of such a component. In addition to that or in an alternative, at least one of the mechanical securing devices may comprise at least one magnet or be implemented by way of such a magnet.

In preferred embodiments, the incubator-side interface and/or the holding-frame-side interface comprise or comprises magnetic connection elements.

In further preferred embodiments, at least one of the components of incubator-side interface and holding-frame-side interface comprise a seal for thermal isolation and/or for sealing against the passage of gas. At least one of the seals may be a seal that partially or completely encircles the interface.

In preferred configurations of the invention, a sample space with controllable climate is formed by at least the incubator module and the holding frame.

In principle, the invention can be implemented using an incubator module which just like the holding frame has no active components for climate control in the sample space. For example, such an incubator module could be realized by a lid or a cover to be placed on the holding frame.

However, the incubator module comprises active devices for climate control in the sample space in advantageous exemplary embodiments of the microscope according to the invention. In particular, provision may advantageously be made for only the incubator module to comprise active devices for climate control in the sample space.

For example, a temperature control device, in particular a regulable temperature control device, for heating and/or cooling the sample space may be present as active device. The temperature control device may comprise a temperature measuring device, in particular in the interior of the sample space. For example, the temperature measuring device may comprise a thermocouple.

Furthermore, the temperature control device may comprise a heating device and/or a cooling device. In particular, the temperature control device may comprise an ohmic heating, for example having at least one heating wire and/or having at least one heating foil.

In addition to that or in an alternative, the temperature control device may comprise a Peltier element for heating and/or cooling the sample space.

In addition to that or in an alternative, the temperature control device may comprise at least one fluid channel that is formed in the incubator module, for example in a frame of the incubator module, for the purpose of passing a heated or cooled fluid, for example air or water, in order to control the temperature in the sample space.

However, it is also possible that a temperature control device is formed outside of the incubator module. For example, the temperature control device may comprise an infrared lamp, by means of which the holding frame and a sample holder can be irradiated from a side that faces away from the incubator module. In addition to that or in an alternative, the temperature control device may comprise a fan, by means of which the holding frame and/or a sample holder can be impinged by a heated or cooled gas, in particular air, from a side that faces away from the incubator module.

In order to provide a desired atmosphere in the sample space, i.e. desired partial pressures of different gases, the incubator module in a preferred embodiment variant of the microscope according to the invention comprises a device for introducing gas into the sample space.

It is also possible that the temperature control device comprises a gas inlet for letting a gas, in particular a heated or cooled gas, for example air or nitrogen, into the sample space. Consequently, the device for introducing gas into the sample space may also realize the function of a temperature control device.

The phrase temperature control for an object, in particular the sample, refers to the process whereby the object, in particular the sample, is brought to a specific target temperature and kept at this target temperature or approximately at this target temperature for at least a certain amount of time.

Depending on the ambient temperature and the target temperature, heat must be removed from or supplied to the object, for example the sample. The sample must optionally be heated or cooled. The sample can be heated or cooled by blowing a heated or cooled gas, for example air or nitrogen, into the sample space.

In addition to that or in an alternative, the temperature of the sample space can be controlled by controlling the temperature of the incubator module. For example, temperature control can be performed by controlling the temperature of a lid of the incubator module. In addition to that or in an alternative, the temperature of the sample space can be controlled by controlling the temperature of a frame of the incubator module. In addition to that or in an alternative, the temperature of the sample space can be controlled by controlling the temperature of a region of the holding frame or of the sample holder facing away from the incubator module. By way of example, the temperature of the sample space can be controlled by controlling the temperature of the holding frame and/or of the sample holder.

In principle, the invention can be implemented using an incubator module formed from a single part. In advantageous embodiment variants, the incubator module comprises at least a frame and a lid. The term frame is intended to denote a component which in the mathematical-topological sense substantially is a ring-shaped component. Particularly preferably, an incubator-side interface, or the incubator-side interface, may be formed on a frame of the incubator module. The frame of the incubator module on which the incubator-side interface is formed may comprise at least a part of an active device for climate control in the sample space.

The incubator module may comprise at least one further frame that is arranged between the frame on which the incubator-side interface is formed and the lid of the incubator module. The further frame may comprise at least a part of an active device for climate control in the sample space. However, it is also possible that the further frame and/or the frame on which the incubator-side interface is formed do or does not comprise any active device for climate control and only serve or serves to provide a suitable height of the incubator module above a sample to be examined.

The lid may also comprise at least a part of an active device for climate control in the sample space. Finally, the active devices for climate control in the sample space may be formed in full in the lid of the incubator module.

In preferred configurations of the microscope according to the invention, at least one or all of the active devices for climate control in the sample space can be set and/or controlled manually. The control unit may expediently be configured to control at least one, some or all of the active devices.

A further preferred exemplary embodiment is distinguished in that the holding frame is formed such that it can also be used for microscopy even without the incubator module. This can further increase the functionality of the microscope.

In a further preferred embodiment, a leveling device is arranged amid the holding frame and configured to adapt an alignment of the holding frame relative to an optical axis of the microscope. For example, the leveling device may be configured for swiveling, in particular independent swiveling, of the holding frame about axes of rotation that in each case run substantially perpendicular to one another and to the optical axis. For example, the leveling device may be implemented by three adjustable leveling screws.

In the system according to the invention, at least two of the holding-frame-side interfaces and/or at least two of the incubator-side interfaces may differ in each case. The advantages of the invention are particularly clearly evident in configurations of the system according to the invention in which the holding-frame-side interfaces are identical in each case and/or the incubator-side interfaces are identical in each case.

Further advantages and features of the present invention are explained below in association with the figures, in which:

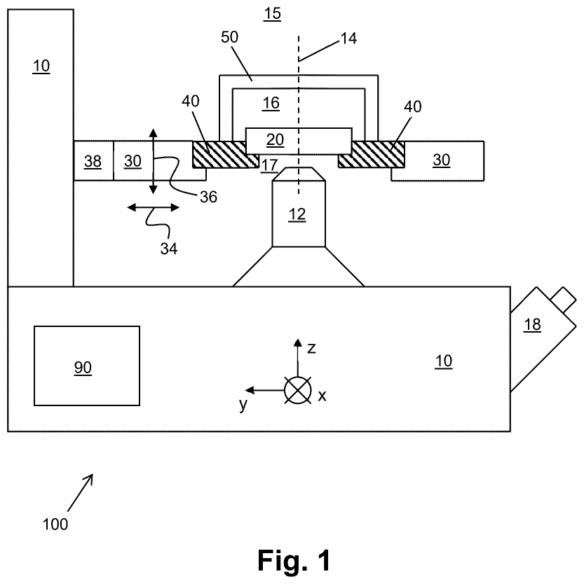

FIG. 1: shows a schematic illustration of one exemplary embodiment of a microscope according to the invention;

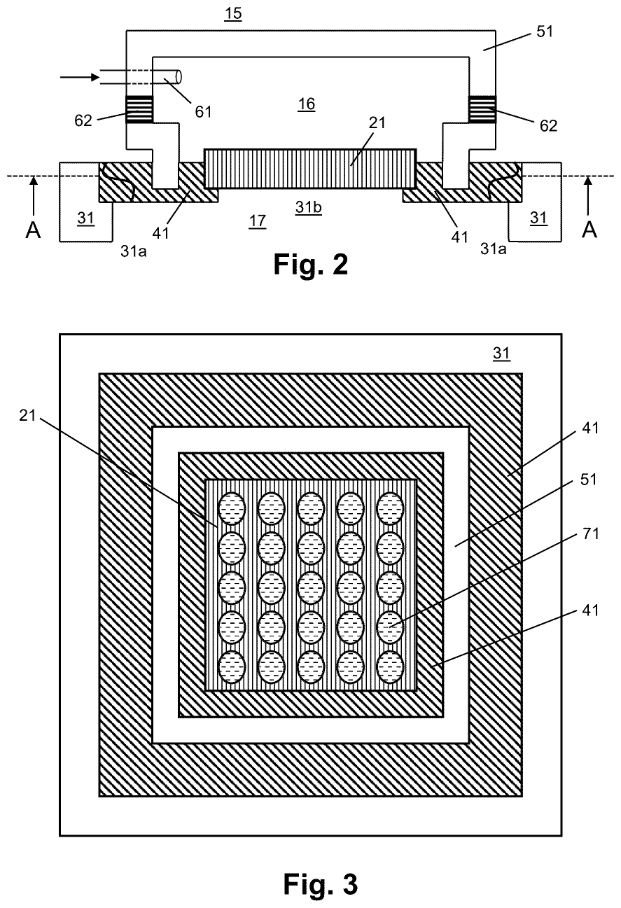

FIG. 2: shows a schematic and cutaway partial view of a further exemplary embodiment of a microscope according to the invention;

FIG. 3: shows a view of the exemplary embodiment shown in FIG. 2, along the section line A-A in FIG. 2;

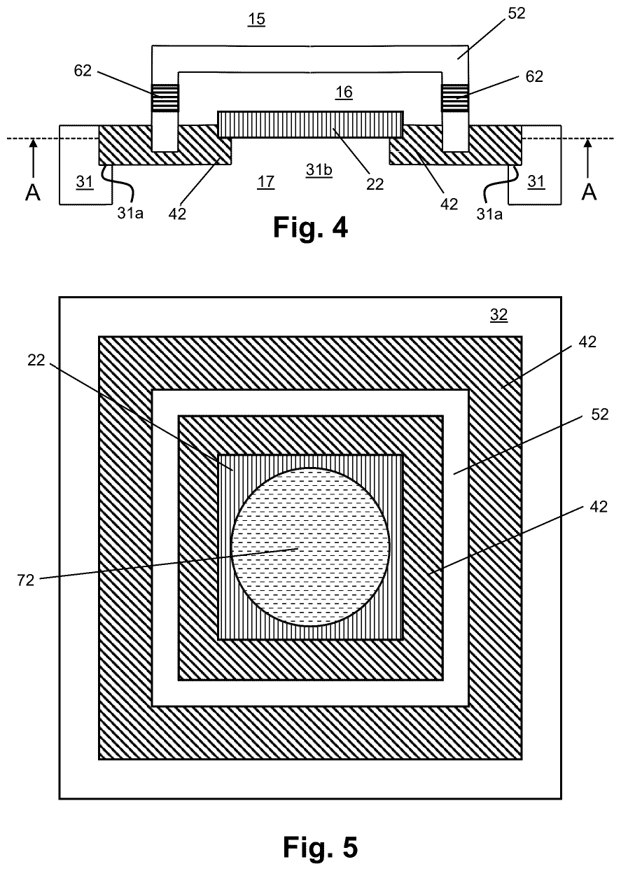

FIG. 4: shows a schematic and cutaway partial view of a further exemplary embodiment of a microscope according to the invention;

FIG. 5: shows a view of the exemplary embodiment shown in FIG. 4, along the section line A-A in FIG. 4;

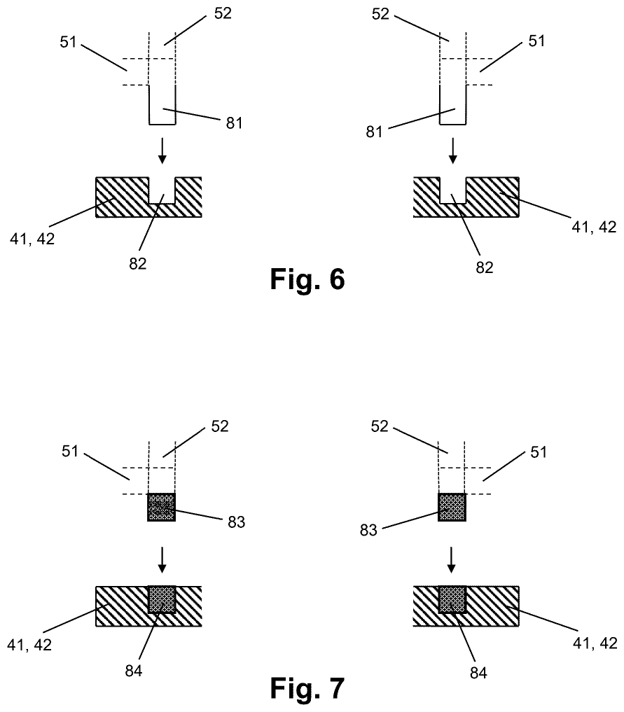

FIG. 6: shows a first exemplary embodiment of a mechanical interface between an incubator module and a holding frame for a microscope according to the invention;

FIG. 7: shows a second exemplary embodiment of a mechanical interface between an incubator module and a holding frame for a microscope according to the invention;

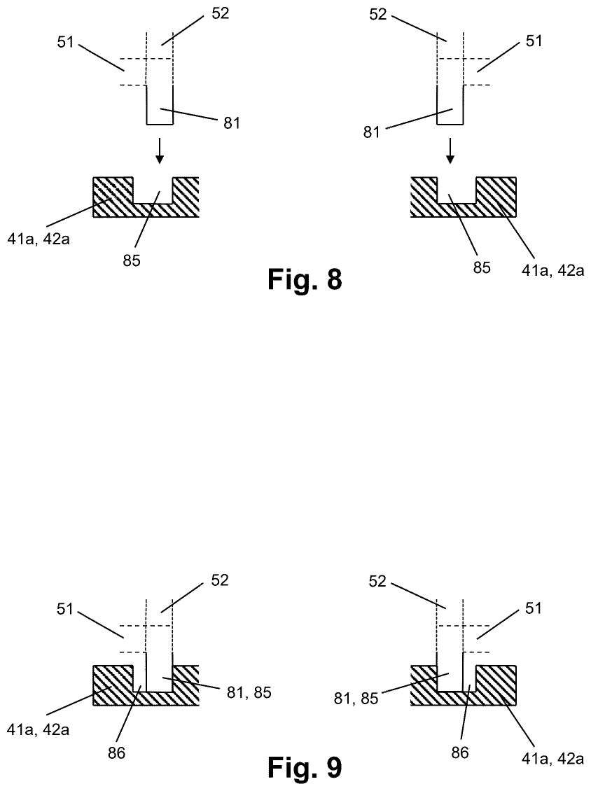

FIG. 8: shows a third exemplary embodiment of a mechanical interface between an incubator module and a holding frame for a microscope according to the invention, in a non-connected situation; and

FIG. 9: shows the exemplary embodiment of the mechanical interface of FIG. 8 in a situation in which the incubator module is in engagement with the holding frame, as intended.

Identical and identically acting components are generally provided with the same reference signs in the figures.

One exemplary embodiment of a microscope 100 according to the invention will be explained with reference to FIG. 1. The microscope 100 according to the invention, shown schematically in a sectional view, initially comprises a microscope stand 10 and a microscope objective 12 arranged on the microscope stand. Furthermore, the microscope 100 comprises a holding frame 40 for receiving a sample 20. Finally, a sample stage 30 having a receiving device for receiving the holding frame 40 is a part according to the invention of the microscope 100. In the situation shown by way of example in FIG. 1, the holding frame 40 is received as intended in the receiving device of the sample stage 30, said receiving device being formed in the region of an opening in the sample stage 30. According to the invention, the microscope 100 also comprises an incubator module 50 that is arranged on the holding frame 40. According to the invention, the incubator module 50 and the holding frame 40 jointly enclose a sample space 16 at least in part. According to the invention, the holding frame 40 is free from active devices for climate control in the sample space 16. This means that the holding frame 40 does not comprise any active devices for climate control in the sample space 16. The holding frame 40 thus substantially fulfills a mechanical function, wherein thermal conduction properties of the holding frame may be suitably designed and rendered usable.

In the exemplary embodiment shown, the microscope stand 10 is an inverted stand, i.e. the microscope objective 12 has a line of sight from below to the sample or the sample carrier 20. For example, the microscope objective 12 may be arranged on an objective turret (not depicted here). An optical axis of the microscope objective 12 is labeled by reference sign 14. Moreover, FIG. 1 shows an eyepiece 18 schematically and in exemplary fashion; however, the latter is not required for the realization of the invention. By way of example, the sample or the sample carrier 20 may be a microscope slide with a biological sample.

As depicted schematically, the sample carrier 20 is arranged in a receptacle of the holding frame 40. The holding frame might be a metallic frame-like component, for example a component manufactured from aluminum, which in turn is arranged in the receptacle formed on the sample stage 30. Frame-like means that the component is substantially ring-shaped in the mathematical-topological sense. The sample stage 30 is also substantially ring-shaped in the mathematical-topological sense. This means that both the holding frame 40 and the sample stage 30 have an opening through which the microscope objective 12 has along its optical axis 14 an optical line of sight to the sample carrier 20. As evident from FIG. 1, the receptacle for the sample carrier 20 in the holding frame 40 is formed by a projection of the holding frame 40 (without reference sign) which points into the interior of the opening, i.e. in the direction of the optical axis 14 of the microscope objective 12, and on which the sample carrier 20 is mounted on account of gravity. In FIG. 1, gravity acts in the direction of the negative z-direction. A right-handed and orthogonal coordinate system is specified in the lower region of the microscope stand 10. The receptacle for the holding frame 40 in the sample stage 30 is also formed by a projection of the sample stage 30 (without reference sign) which points into the interior of the opening, i.e. in the direction of the optical axis 14, and on which the holding frame 40 is mounted on account of gravity. In the exemplary embodiment shown, the incubator module 50 rests on the holding frame 40. For example, magnets may be present for securing the incubator module 50 relative to the holding frame 40. An example of such a connection is explained below.

The sample space 16 is at least partially thermally isolated from a region 15 located outside of the incubator module 50 by way of the incubator module 50 and the sample holder 20.

In the exemplary embodiment shown, the sample stage 30 is an xyz-displacement stage. This means that the sample stage 30, and hence the holding frame 40 and the sample carrier 20, can be put into a desired target position relative to the optical axis 14 of the microscope objective 12 both laterally, i.e. in the positive and negative x-direction and in the positive and negative y-direction (illustrated by the double-headed arrow 34), and axially, i.e. in the positive and negative z-direction. The option for manipulating in the lateral directions is illustrated in FIG. 1 by the double-headed arrow 34, and the option for manipulating in the axial direction is illustrated by the double-headed arrow 36. A schematically shown motorized drive 38 is present for moving the sample stage 30 in the lateral directions and in the axial direction.

In a variant, the sample stage 30 could moreover comprise a device for varying the distance of the holding frame 40, in particular in the direction of an optical axis 14 of the microscope objective 12, relative to the microscope objective 12. For example, this device might comprise a piezo actuator that is arranged between the sample stage 30 and the holding frame 40.

Finally, the exemplary embodiment shown contains a control unit 90, for example a PC, which may be configured to control the components of the microscope, for example of the sample stage 30, of an objective turret and/or of a piezo actuator. In a manner known per se, the control unit may also serve to evaluate data from a detector (not shown) for acquiring microscopic measurement data. A light source that can be used to illuminate the sample 20 with light, for example excitation light for fluorescent dyes with which the sample was prepared, is not shown either. For example, such a light source could be situated in a region 17 below the sample carrier 20, i.e. on a side of the sample carrier facing away from the incubator module 50.

A second exemplary embodiment of a microscope according to the invention will be explained on the basis of FIGS. 2, 3 and 6. FIGS. 2 and 3 each show a cutaway partial view of the microscope with a sample holder 21, a sample stage 31, a holding frame 41 and an incubator module 51. In principle, the components of the microscope according to the invention not depicted in FIGS. 2 and 3 may be embodied in the same way as shown in FIG. 1. In this context, FIG. 3 shows a sectional view along the line denoted by arrows A-A. The optical axis 14 of the microscope objective 12 not shown in FIGS. 2 and 3 runs in the vertical direction in FIG. 2, as in FIG. 1, and is perpendicular to the plane of the drawing in FIG. 3.

The sample stage 31, the holding frame 41 and the incubator module 51 are constructed similarly to the sample stage 30, the holding frame 40, and the incubator module 50, respectively, in FIG. 1. Differences of the holding frame 41 and the incubator module 51 are found in the region where said components are in mechanical contact with each other. Additionally, the holding frame 41 is designed to receive the sample holder 21, which is a multiwell sample holder. As shown schematically in FIG. 3, the sample holder 21 contains a total of 25 “wells”, i.e. cavities or depressions 71 for receiving different samples. By suitably positioning the sample stage 31 relative to the optical axis 14 of the microscope objective 12, the desired wells, for example a portion containing a total of four of the wells 71, can in each case be brought into the field of view of the microscope objective 12.

A region of the opening in the sample stage 31 and in the holding frame 41 is denoted by reference sign 31b in FIG. 2. The inwardly projecting shoulder, i.e. the shoulder pointing in the direction of the opening 31b, on which the holding frame 41 is mounted on the sample stage 31 as a result of gravity is labeled by reference sign 31a.

For the provision of suitable climactic conditions in the sample space 16, the incubator module 51 shown schematically in FIG. 2 comprises a heating device 62, for example formed by heating wires, and an opening 61, through which a desired gas can be introduced into the sample space 16 from the outside. The temperature of the gas may likewise be controlled.

A mechanical interface, which is explained in the context of FIG. 6, is formed between the incubator module 51 and the holding frame 41. FIG. 6 only shows those regions of the incubator module 51 and of the holding frame 41 that are intended to come into contact with each other. FIG. 6 moreover shows the incubator module 51 in a state in which it is lifted relative to the holding frame 41 and is consequently not in engagement with the holding frame 41.

The mechanical interface comprises a groove 82 that encircles the opening 31b (see FIG. 2) as holding-frame-side interface and a protruding collar that also encircles the opening 31b, or an encircling protruding key 81, as incubator-side interface. In the exemplary embodiment shown, the collar or the key 81 is formed in such a way that it can be received interlockingly in the groove 82 of the holding frame. For this purpose, the incubator module 51 is placed into the holding frame 41 in the direction of the downwardly pointing arrows in FIG. 6.

A third exemplary embodiment of a microscope according to the invention will be explained on the basis of FIGS. 4 to 6. FIGS. 4 and 5 each show a cutaway partial view of the microscope with a sample holder 22, a sample stage 32, a holding frame 42 and an incubator module 52. Only the differences in comparison with the exemplary embodiment of FIGS. 2 and 3 will be explained here.

The sample holder 22 is a sample holder for a petri dish 72. In comparison with the incubator module 51 from FIG. 2, the incubator module 52 is a simpler variant, which only contains the heating device 62. In comparison with the sample holder 21 from FIGS. 2 and 3, the sample holder 22 has a different geometry. The holding frame 42 also differs from the holding frame 41 in the region of the receptacle for the sample holder 22.

However, in comparison with the exemplary embodiment of FIGS. 2 and 3, there are no differences in the region of the mechanical interface formed between the incubator modules 51, 52 and the holding frames 41, 42. This is depicted schematically in FIG. 6. This means that with its protruding encircling collar 81, the incubator module 52 can be inserted into an encircling groove 82 formed in the holding frame 42 in both the exemplary embodiment of FIGS. 4 and 5 and in the exemplary embodiment of FIGS. 2 and 3, as described above.

A further example of a mechanical interface is described with reference to FIGS. 8 and 9. Only the differences in comparison with the exemplary embodiment of FIG. 6 will be explained. In the exemplary embodiment shown in FIGS. 8 and 9, the holding frame 41 has been replaced by a modified holding frame 41a, and the holding frame 42 has been replaced by a modified holding frame 42a. The difference in comparison with the exemplary embodiment of FIG. 6 consists in the fact that in comparison with the groove 82 from FIG. 6, the groove 85 in the holding frames 41a, 42a is broadened radially outwardly and consequently wider than the protruding collar or the key 81. In situations in which the incubator module 51 is inserted into the holding frame 41a and the incubator module 52 is inserted into the holding frame 42a, this leads to the protruding collar 81 contacting the corresponding holding frame only radially on the inside, as illustrated in FIG. 8. By contrast, an air gap 86 is formed on the radially outer side. In this exemplary embodiment, the protruding collar 81, when engaging in the groove 85, is configured to contact a radially interior wall of the groove 85 and form an air gap 86 with respect to a radially outer wall of the groove 85. This variant allows thermal conduction between the respective incubator module and a part of the respective holding frame facing the sample space 16 to be greater than thermal conduction between the incubator module and a part of the holding frame facing away from the sample space 16.

The particular advantage of the invention whereby the holding frames and the incubator modules 51, 52 can be combined with each other as desired on account of the same configuration of the mechanical interfaces is evident here. The different holding frames 41, 42, 41a, 42a and the different incubator modules 51, 52 form a system according to the invention for a microscope of the type shown in FIG. 1, in which system each of the holding frames 41, 42, 41a, 42a comprises a holding-frame-side interface 81 or 85 and each of the incubator modules 51, 52 comprises an incubator-side interface 82, wherein each of the holding-frame-side interfaces can be brought into engagement with each of the incubator-side interfaces 82 during intended use.

The holding-frame-side interfaces 81 and the incubator-side interfaces 82 are in each case identical in the exemplary embodiments described in the context of FIGS. 2 to 6.

FIG. 7 shows an alternative variant for the mechanical interface, in which the incubator-side interface is formed by a circumferential magnet 83 in each case. The holding-frame-side interface in each case also comprises a circumferential material region 84 made of a magnetic material.

Here, too, the holding frames and the incubator modules 51, 52 can be combined with each other as desired on account of the same configuration of the mechanical interfaces.

The present invention proposes a novel microscope and a novel system for microscope components which, while in principle providing the same experimental or metrological options, allow a substantial reduction in the number of components to be kept available.

### LIST OF REFERENCE SIGNS

10 Microscope stand
12 Microscope objective
14 Optical axis of microscope objective 12
15 Region outside of incubator volume 16
16 Incubator volume, sample space
17 Side of the sample holder 21, 22 facing away from the incubator module
18 Eyepiece
20 Sample, sample holder, microscope slide
21 Sample, sample holder, multiwell sample carrier
22 Sample, sample holder for a petri dish
30 Sample stage, xyz-displacement stage
31 Sample stage, xyz-displacement stage
31a Protruding collar, part of the receiving device of sample stage 31
31b Opening in the sample stage 31 and holding frame 41
32 Sample stage, xyz-displacement stage
32a Protruding collar, part of the receiving device of sample stage 32
32b Opening in the sample stage 32 and holding frame 42
34 Double-headed arrow (adjustment in y-direction)
36 Double-headed arrow (adjustment in z-direction)
38 Drive for adjusting the sample stage 30 in the x-, y-, z-directions
40 Holding frame
41 Holding frame
41a Holding frame with a wider groove 85
42 Holding frame
42a Holding frame with a wider groove 85
50 Incubator module
51 Incubator module with temperature control and gas supply
52 Incubator module with temperature control
61 Device for introducing gas
62 Heating device
71 Sample region in the multiwell sample carrier 21
72 Petri dish
81 Incubator-side interface device, protruding collar, key
82 Holding-frame-side interface device, groove
83 Magnet
84 Magnet or ferromagnetic material
85 Holding-frame-side interface device, widened groove
86 Air gap
100 Microscope according to the invention

1. A microscope, comprising:
a microscope stand,
at least one microscope objective arranged on the microscope stand,
a holding frame for receiving at least one sample and/or at least one sample carrier and/or at least one combination of a sample and a sample carrier,
a sample stage comprising a receiving device for receiving the holding frame,
an incubator module that is arrangeable on the holding frame and furthermore wherein
the incubator module and the holding frame jointly enclose a sample space at least in part and
the holding frame is free from active devices for climate control in the sample space.

2. The microscope as claimed in claim 1,
wherein
the sample stage comprises a device for varying the distance of the holding frame relative to the microscope objective.

3. The microscope as claimed in claim 1,
comprising a control unit that serves to control components of the microscope and is configured to control at least one of the following components:
motorized drive or motorized drives of the sample stage,
objective changer,
device for varying the distance of the holding frame relative to the microscope objective.

4. The microscope as claimed in claim 1,
wherein
a mechanical interface is formed between the incubator module and the holding frame.

5. The microscope as claimed in claim 4,
wherein
the mechanical interface comprises an incubator-side interface on the incubator module and/or
the mechanical interface comprises a holding-frame-side interface on the holding frame.

6. The microscope as claimed in claim 4,
wherein
the mechanical interface is configured to thermally isolate the sample space and a region outside the sample space from each other.

7. The microscope as claimed in claim 4,
wherein
the mechanical interface is configured to allow thermal conduction between the incubator module and a part of the holding frame facing the sample space, said thermal conduction being greater than thermal conduction between the incubator module and a part of the holding frame facing away from the sample space.

8. The microscope as claimed in claim 5,
wherein
the incubator-side interface and/or the holding-frame-side interface comprises a groove and
the respective other interface comprises a protruding collar configured to engage in the groove.

9. The microscope as claimed in claim 8,
wherein
the protruding collar, when engaging in the groove, contacts a radially interior wall of the groove and forms an air gap with respect to a radially outer wall of the groove.

10. The microscope as claimed in claim 5,
wherein
the incubator-side interface and/or the holding-frame-side interface comprises magnetic connection elements.

11. The microscope as claimed in claim 1,
wherein
the incubator module comprises active devices for climate control in the sample space.

12. The microscope as claimed in claim 11,
wherein
a temperature control device for heating and/or cooling the sample space is present as an active device.

13. The microscope as claimed in claim 12,
wherein
the temperature control device comprises at least one of:
an ohmic heating device comprising heating wires or heating foils;
a Peltier element for heating and/or cooling the sample space;
at least one fluid channel that is formed in the incubator module for the purpose of passing a heated or cooled fluid in order to control the temperature in the sample space;
an infrared lamp with which the holding frame and a sample holder can be irradiated from a side that faces away from the incubator module;
a fan with which the holding frame and/or a sample holder can be impinged by a heated or cooled gas from a side that faces away from the incubator module; or
a gas inlet for letting a heated or cooled gas into the sample space.

14-17. (canceled)

18. The microscope as claimed in claim 1,
wherein
the incubator module comprises a device for introducing gas into the sample space.

19. (canceled)

20. The microscope as claimed in claim 1,
wherein
the incubator module comprises at least a frame and a lid.

21. The microscope as claimed in claim 20,
wherein
an, or the, incubator-side interface is formed on a frame of the incubator module.

22. The microscope as claimed in claim 21,
wherein
the frame of the incubator module on which the incubator-side interface is formed comprises at least a part of an active device for climate control in the sample space.

23. The microscope as claimed in claim 20,
wherein
the incubator module comprises at least one further frame that is arranged between the frame on which the incubator-side interface is formed and the lid of the incubator module.

24. The microscope as claimed in claim 23,
wherein
the further frame comprises at least a part of an active device for climate control in the sample space.

25. The microscope as claimed in claim 20,
wherein
the lid comprises at least a part of an active device for climate control in the sample space.

26. The microscope as claimed in claim 11,
wherein
at least one, some or all of the active devices for climate control in the sample space can be set and/or controlled manually and
wherein a control unit is configured to control at least one, some or all of the active devices.

27. The microscope as claimed in claim 1,
wherein
the holding frame is formed such that it can also be used for microscopy even without the incubator module.

28. The microscope as claimed in claim 1,
wherein
a leveling device is arranged amid the holding frame and configured to adapt an alignment of the holding frame relative to an optical axis of the microscope.

29. A system having a plurality of different holding frames and a plurality of different incubator modules as claimed in claim 1,
wherein
each of the holding frames comprises a holding-frame-side interface,
each of the incubator modules comprises an incubator-side interface and
each of the holding-frame-side interfaces can be made to engage with each of the incubator-side interfaces when used as intended.

30. The system as claimed in claim 29,
wherein
at least two of the holding-frame-side interfaces and/or at least two of the incubator-side interfaces differ in each case.

31. The system as claimed in claim 29,
wherein
the holding-frame-side interfaces are identical in each case and/or the incubator-side interfaces are identical in each case.
